(19) United States
(12) Patent Application Publication
(10) Pub. No.: US 2011/0255886 A1
(43) Pub. Date: Oct. 20, 2011

(54) Image forming apparatus and control method thereof

(75) Inventor: Jun-suk Kwak, Gwangju-si (KR)

(73) Assignee: SAMSUNG ELECTRONIS CO., LTD., Suwon-si (KR)

(21) Appl. No.: 12/926,080

(22) Filed: Oct. 25, 2010

(30) Foreign Application Priority Data
Apr. 16, 2010 (KR) 10-2010-0035560

(51) Int. Cl. G03G 15/08

(52) U.S. Cl. 399/27

(57) ABSTRACT

A control method of an image forming apparatus which includes a developer supply unit supplying a toner and a developing unit accommodating therein a two-component developer having the toner supplied by the developer supply unit and a carrier mixed, the control method including: performing a print operation according to a print command; calculating an average toner consumption volume of the image at a preset first interval; determining a value of a first parameter according to the calculated average toner consumption volume by using a table storing therein in advance the value of the first parameter for a timing of starting mixing of the developer corresponding to the average toner consumption volume; determining whether to start the mixing by using the determined value of the first parameter; and suspending the print operation according to the determination result and mixing the two-component developer accommodated in the developing unit.

### CROSS-REFERENCE TO RELATED APPLICATIONS

This application claims priority from Korean Patent Application No. 10-2010-0035560, filed on Apr. 16, 2010 in the Korean Intellectual Property Office, the disclosure of which is incorporated herein by reference.

### BACKGROUND

1. Field

Apparatuses and methods consistent with the exemplary embodiments relate to an image forming apparatus and a control method thereof, and more particularly, an image forming apparatus and a control method thereof which controls a mixing of a two-component developer.

2. Description of the Related Art

An image forming apparatus such as a printer, a photocopier, a facsimile, or a multi-function device forms an image on a print medium by an electrophotographic, inkjet or heat transfer method. In particular, a color image forming apparatus includes a plurality of developing units in each color to form a plurality of color images, e.g., yellow (Y), magenta (M), cyan (C) and black (K) images. The color image forming apparatus further includes a developing cartridge which is separate from the developing unit and supplies developers in each color corresponding to the developers, if required.

The developer which is accommodated in the developing unit includes a one-component developer using only a toner supplied by a developing cartridge and a two-component developer using a toner and a carrier. The two-component developer enables a high-speed development compared to the one-component developer and provides good realization in gray scale and thus is widely used.

In the development in which the two-component developer is used, a concentration of the developer is controlled by using an output value of a concentration controlling sensor sensing the concentration of the toner.

In the conventional development in which the concentration controlling sensor is used, the concentration of the developer is measured by permeability of the carrier, and an error which misinterprets air as the concentration of the toner excluding the carrier in the developer may arise.

Also, if images whose toner ratio is approximately 25 to 100%, so-called ultra high coverage images are consecutively printed, an output of the concentration controlling sensor becomes unstable due to a change in packing of the developer. Thus, even if the concentration is properly maintained, the concentration controlling sensor misrecognizes the toner as insufficient and may oversupply the toner.

If large quantities of toner are supplied in an instant by oversupply, the toner and carrier are not sufficiently mixed and uniform concentration of images is hardly maintained. Further, spatter of toner occurs, and the developer may malfunction if the above operation continues.

### SUMMARY

Accordingly, one or more exemplary embodiments provide an image forming apparatus and a control method thereof which prevents an oversupply of a toner due to an error in a concentration controlling sensor according to a change in packing of a developer, and in particular, maintains a uniform concentration of images in a consecutive print of an ultra high coverage to prevent spatter of a toner and maintains a print speed as quickly as possible.

The foregoing and/or other aspects may be achieved by providing a control method of an image forming apparatus which includes a developer supply unit supplying a toner and a developing unit accommodating therein a two-component developer having the toner supplied by the developer supply unit and a carrier mixed, the control method including: performing a print operation according to a print command; calculating an average toner consumption volume of the image at a preset first interval; determining a value of a first parameter according to the calculated average toner consumption volume by using a table storing therein in advance the value of the first parameter for a timing of starting mixing of the developer corresponding to the average toner consumption volume; determining whether to start the mixing by using the determined value of the first parameter; and suspending the print operation according to the determination result and mixing the two-component developer accommodated in the developing unit.

The determining the value of the first parameter may include accumulating the value of the first parameter at every preset first interval; and the determining whether to start the mixing may include comparing the cumulative value of the first parameter with a mixing start judge level.

The prestored value of the first parameter may be set as large if the average toner consumption volume is large and set as small if the average toner consumption volume is small.

The table may further store therein a value of the second parameter for a mixing time corresponding to the average toner consumption volume; and the determining the value of the first parameter may include determining a value of the second parameter according to the calculated average toner consumption volume.

The determining the value of the second parameter may include accumulating the value of the second parameter at every preset first interval; and the mixing the developer may include mixing the developer for the time corresponding to the cumulative value of the second parameter.

The value of the second parameter may be set as large if the average toner consumption volume is large and set as small if the average toner consumption volume is small.

The table may further store therein a value of the third parameter for a timing of starting the toner supply corresponding to the average toner consumption volume; and the determining the value of the first parameter may include determining a value of the third parameter according to the calculated average toner consumption volume.

The control method may further include sensing a concentration of the two-component developer accommodated in the developing unit at a preset second interval, wherein the determining the value of the third parameter may include accumulating the value of the third parameter at the preset first interval.

The control method may further include determining whether to supply the toner by comparing the sensed concentration of the developer and the cumulative value of the third parameter, wherein the mixing the developer may include supplying the toner and mixing the developer after suspending the print operation according to the determination result.

The average toner consumption volume may be set in each predetermined range with respect to a coverage of a printed image.

The control method may further include resuming the suspended print operation if the mixing operation is completed.

The foregoing and/or other aspects may be achieved by providing an image forming apparatus including: a developer supply unit which supplies a toner; an image forming unit which includes a developing unit accommodating therein a two-component developer having a toner supplied by the developer supply unit and a carrier mixed, and including a mixer mixing the two-component developer and a mixing driver driving the mixer, and forms an image according to a print command; a storage unit which stores therein a table storing in advance a value of a first parameter for a timing of starting a mixing of the developer corresponding to an average toner consumption volume; and a controller which calculates an average toner consumption volume of the image at a preset first interval, determines a value of the first parameter according to the calculated average toner consumption volume by using the table, determines whether to mix the developer by using the determined value of the first parameter and controls the image forming unit to suspend the print operation according to a determination result and controls the mixing driver to mix the two-component developer accommodated in the developing unit.

The controller may accumulate the value of the first parameter at the preset first interval and determine whether to start the mixing by comparing the cumulative value of the first parameter with a mixing start judge level.

The prestored value of the first parameter may be set as large if the average toner consumption volume is large and set as small if the average toner consumption volume is small.

The table may further store therein a value of the second parameter for a mixing time corresponding to the average toner consumption volume, and the controller may further determine a value of the second parameter according to the calculated average toner consumption volume.

The controller may accumulate the value of the second parameter at the preset first interval and control the mixing driver to mix the developer for a time corresponding to the cumulative value of the second parameter.

The value of the second parameter may be set as large if the average toner consumption volume is large and set as small if the average toner consumption volume is small.

The table may further store therein a value of the third parameter for a timing of starting a toner supply corresponding to the average toner consumption volume, and the controller may further determine a value of the third parameter according to the calculated average toner consumption volume.

The image forming apparatus may further include a concentration sensor which senses a concentration of the two-component developer accommodated in the developing unit at a preset second interval, wherein the controller may accumulate the value of the third parameter at the preset first interval.

The controller may further determine whether to supply the toner by comparing the sensed concentration of the developer with the cumulative value of the third parameter, and supply the toner and mixes the developer after suspending the print operation according to the determination result.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a schematic sectional view of an image forming apparatus according to an exemplary embodiment;

FIG. 2 is a block diagram of the image forming apparatus according to the exemplary embodiment;

FIG. 3 illustrates an example of variation of a parameter of an average toner consumption volume in each range according to a parameter table in Table 1;

FIG. 4 is a graph which illustrates output properties of a sensor between toner consumption and supply when an ultra high coverage is consecutively printed;

FIGS. 5 and 6 are graphs which sequentially illustrate first to third parameters A, B and C and a concentration sensor output in the image forming apparatus according to the exemplary embodiment;

FIG. 7 is a flowchart which illustrates a control method of the image forming apparatus according to the exemplary embodiment;

FIG. 8 is a flowchart which illustrates a control method of the image forming apparatus according to another exemplary embodiment; and

FIGS. 9 and 10 are graphs which illustrate problems of a conventional art.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

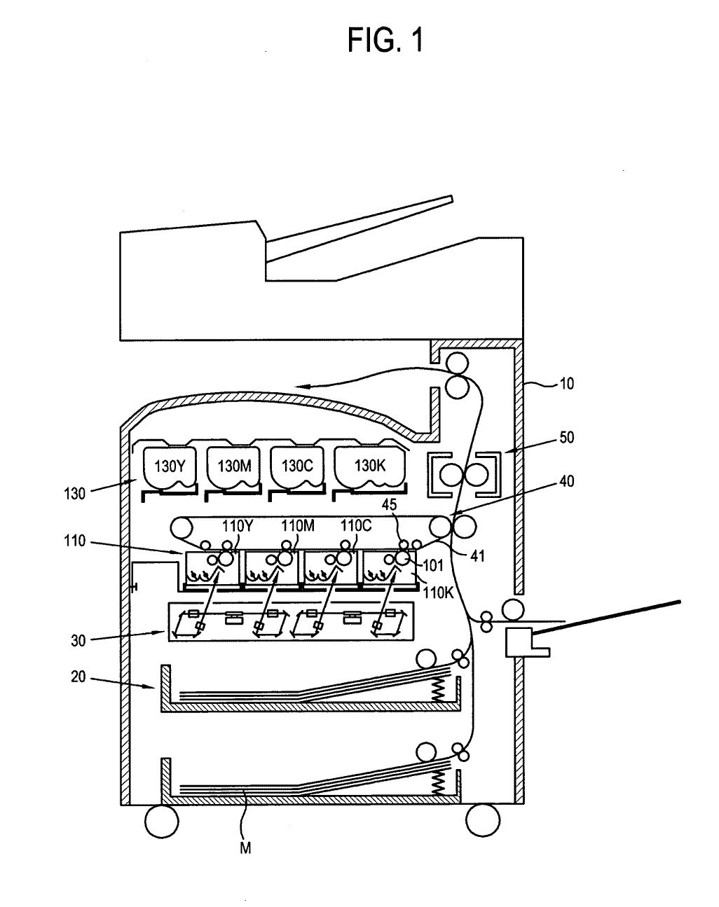

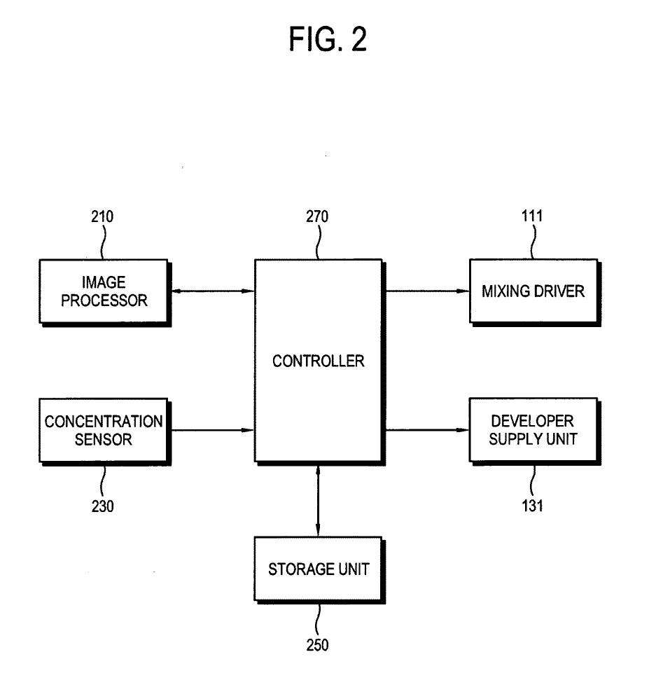

FIG. 1 is a schematic sectional view of an image forming apparatus according to an exemplary embodiment. FIG. 2 is a block diagram of the image forming apparatus according to the exemplary embodiment.

Referring to FIG. 1, the image forming apparatus according to the exemplary embodiment is a tandem color image forming apparatus which forms a color image by a single path method. The image forming apparatus includes a developing unit 110 including an image carrier 101, a light scanning unit 30, a transfer unit 40 and a fusing unit 50.

The image forming apparatus according to the exemplary embodiment may further include a scanning unit which scans a document and forms a scan image, and a medium discharging unit which discharges a print medium M, on which an image is fused, to an outside of a main body housing 10.

The developing unit 110, the light scanning unit 30 and the transfer unit 40 are included in an image forming unit, which performs a print operation according to a print command.

A supply unit 20 in which a print medium M is stored is detachably attached to an inside of the housing 10 forming an external appearance of the image forming apparatus. The print medium M stored in the supply unit 20 is picked up by a pickup roller and then transferred to the transfer unit 40 along a transfer path.

The image carrier 101 forms a latent image in each color by responding to a light beam scanned by the light scanning unit 30. In the present exemplary embodiment, first to fourth image carriers which are arranged sequentially from a supply direction of the print medium M are provided as an example of the plurality of image carriers 101.

The developing unit 110 accommodates therein a toner supplied by a developer supply unit 130, and forms a toner image on the image carrier 101.

The developing unit 110 according to the exemplary embodiment accommodates therein a two-component developer using a toner and a carrier supplied by the developer supply unit 130. The developing unit 110 includes a screw-type mixer (not shown) mixing the developer and a mixing driver 111 driving the mixer.

The developing unit 110 may be plurally provided per color. As an example of the developing unit 110, FIG. 1 illustrates first to fourth developing units 110Y, 110M, 110C and 110K to embody yellow (Y), magenta (M), cyan (C) and black (K) colors. In this case, the developer supply unit 130 includes first to fourth developer supply units 130Y, 130M, 130C and 130K in line with the developing units 110Y, 110M, 110C and 110K in each color.

In the present exemplary embodiment, the developing unit 110 and the developer supply unit 130 are provided separately, but not limited thereto. Alternatively, the developing unit 110 and the developer supply unit 130 may be provided as a single body. In the present exemplary embodiment, the image carrier 101 is provided in the developing unit 110 but not limited thereto. Alternatively, the image carrier 101 may be provided in an external part of the developing unit 110.

The light scanning unit 30 scans light to the plurality of image carriers 101 to form a latent image thereon. The light scanning unit 30 includes a light source (not shown), a beam deflector which deflects and scans light emitted from the light source, a focusing lens focusing the light beam deflected by the beam deflector on the image carrier 101 and a reflection member which converts a moving path of light scanned by the beam deflector.

The transfer unit 40 transfers a visible image formed in the image carrier 110 to the print medium M supplied along a print path. The transfer unit 40 may include a transfer belt 41 and a transfer backup roller 45 which face the plurality of image carriers 101. An image which is transferred to the print medium M through the transfer unit 40 is fused by the fusing unit 50.

As shown in FIG. 2, the image forming apparatus according to the exemplary embodiment may further include an image processor 210, a concentration sensor 230, a storage unit 250 and a controller 270.

The image processor 210 processes an image to form an image printed on a print medium. More specifically, the image processor 210 may encode/decode, reduce/enlarge, scale or color-convert an image to form a desired image.

The concentration sensor 230 is provided in the developing unit 110 accommodating the developer therein, senses a concentration of the developer at a preset sensing interval (second interval), and transmits a sensor output to the controller 270.

The sensing interval may correspond to at least one of a rotation interval of the image carriers 101 and a rotation interval of the mixer mixing the developer accommodated in the developing unit 110.

The sensor output is in inverse proportion to the concentration of the toner accommodated in the developing unit 110.

The controller 270 compares a sensor output of the concentration sensor 230 with a value of a third parameter C, determines whether to supply the toner to the developing unit 110 from the developer supply unit 130, and controls the developer supply unit 130 to supply the toner to the developing unit 110 according to a determination result. The supply of the toner differs from a general supply of a toner performed during a print operation. If the controller 270 determines that the concentration of the toner is significantly low according to the comparison result of the sensor output and the value of the third parameter C, the controller 270 controls the developer supply unit 130 to consecutively supply the toner to thereby raise the concentration of the toner to a certain level while suspending the print operation. With the supply of the toner, the controller 270 controls the mixing driver 111 to mix the two-component developer to raise the concentration of the toner to a preset certain level so that the concentration becomes suitable for the print operation.

The storage unit 250 stores therein a parameter table in which at least one parameter is set corresponding to an average toner consumption volume.

The parameter may include at least one of a first parameter A for a timing of starting mixing, a second parameter B for a mixing time and the third parameter C for a timing of starting a supply of the toner.

The average toner consumption volume is a ratio of the toner of an output medium, and is set for a predetermined range with respect to a coverage of an image. The parameter table may be stored as in Table 1 below.

TABLE 1

| | Parameter | | |
|---|---|---|---|
| Coverage [%] | A | B | C |
| 30~45 | 1 | 1 | 0 |
| 46~60 | 2 | 5 | 0.5 |
| 61~75 | 4 | 13 | 2 |
| 76~100 | 8 | 30 | 5 |

As shown in Table 1 above, the parameter table according to the exemplary embodiment includes the first parameter A for the timing of starting the mixing, the second parameter B for the mixing time and the third parameter C for the timing of starting the supply of the toner in each range (e.g. 30 to 45%, 46 to 60%, 61 to 75% and 76 to 100%) for the coverage of the image. Values of the parameters A, B and C are set as large if the average toner consumption volume is large and as small if the average toner consumption volume is small.

The values of the parameters A, B and C are set in advance at a manufacturing phase to be proportional to the average toner consumption volume, and are not limited to those in Table 1.

The parameter table according to the exemplary embodiment is applicable when an ultra high coverage, whose coverage (the ratio of toner for the output medium) is approximately 30 to 100%, is consecutively printed, but not limited thereto. Alternatively, the parameter table may be applicable to a range other than those in Table 1, i.e., a general high coverage range (e.g. 5 to 29%).

The first to third parameters A, B and C according to the exemplary embodiment are variable parameters depending on a cumulative developer consumption volume, and values of the parameters A, B and C vary corresponding to the average toner consumption volume which is calculated by accumulating a dot count of an image according to the preset first interval.

Initial values of the first and second parameters A and B are set as zero and change at every first interval, and the third parameter C may have a predetermined initial value (e.g., 100V) and vary at every first interval.

The first interval may correspond to at least one of the rotation interval of the image carrier 101 and the rotation interval of the mixer (screw) mixing the developer accommodated in the developing unit 110. The first interval may be the same as the sensing interval of the concentration sensor, i.e., the second interval.

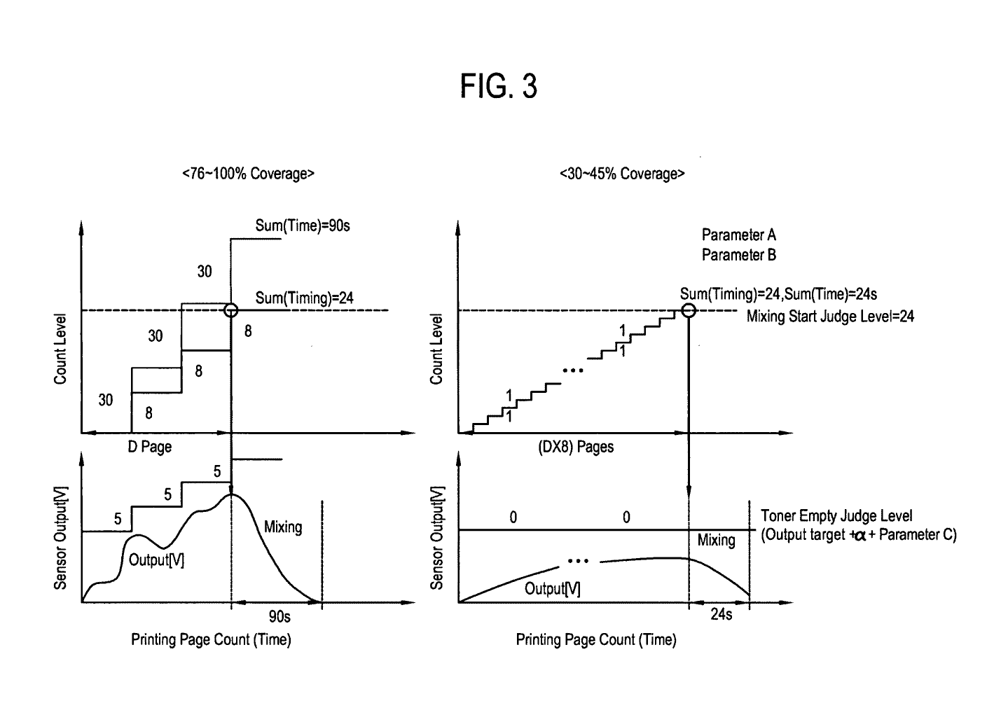

FIG. 3 illustrates an example of parameters varying in each range of the average toner consumption volume according to the parameter table in Table 1.

As shown therein, in case of the range of the 76 to 100%, the value of the first parameter A increases by 8 at the first interval and the value of the second parameter B increases by 30. The value of the third parameter C increases by 5 at the first interval.

Likewise, in case of the range of 30 to 45%, the values of the first and second parameters A and B increase by 1 at the first interval while the value of the third parameter C does not increase.

As shown therein, in case of the range of 76 to 100%, the variable first parameter A increases quickly and reaches the timing of starting the mixing even if the smaller number of pages (D pages) is printed. In case of the range of 30 to 45%, the first parameter A increases the timing of starting the mixing when the relatively large number of pages (D×8 pages) is printed.

Accordingly, the more the toner consumption volume is, the faster the timing of starting the mixing is. The smaller the toner consumption volume is, the slower the timing of starting the mixing is.

The second parameter B increases quickly in the range of 76 to 100% and consumes the toner in large volume and has a longer mixing time. In the range of 30 to 45%, the second parameter B increases slowly and consumes the toner in small volume and has a shorter mixing time.

Even if the sensor output of the concentration sensor 230 abnormally increases in the range having a very high ratio of the toner like the range of 76 to 100%, the value of the third parameter C varies altogether, and the mixing may be performed without supplying the toner to the developing unit 110 from the developer supply unit 130.

In case of the range of 76 to 100% in FIG. 3, the first parameter A reaches a mixing start judge level (Sum (Timing)=24) for the timing of starting the mixing when the print of D pages starts and the mixing is performed. Here, for 90 seconds (Sum (Time)=90 s) corresponding to a cumulative value of the second parameter B, the developer is mixed.

In case of the range of 30 to 45%, the first parameter A reaches the mixing judge level (Sum (Timing)=24) for the timing of starting the mixing and performs the mixing when D×8 pages are printed. Here, for 24 seconds (Sum (Time)=24 s) corresponding to the cumulative value of the second parameter B, the developer is mixed.

The controller 270 receives toner consumption information about an image from the image processor 210 upon reception of a print command. The controller 270 may calculate the average toner consumption volume by accumulating the dot count of the image at the preset first interval corresponding to the rotation of the image carrier 101 or by accumulating the dot count of the image per page.

If the cumulative value of the first parameter A (the cumulative sum of the first parameter A) reaches the mixing start judge level for the timing of starting the mixing during the print operation, the controller 270 controls the image forming unit to suspend the print operation and controls the mixing driver 111 to mix the two-component developer accommodated in the developing unit 110.

If time corresponding to the cumulative value of the second parameter B (cumulative sum of the second parameter B) elapses after the starting of the mixing, the controller 270 controls the mixing driver 111 to suspend the mixing and controls the image forming unit to resume the suspended print operation.

The controller 270 compares the concentration value of the developer sensed by the concentration sensor 230 with the third parameter C, and controls the developer supply unit 130 to supply the toner if the cumulative value of the third parameter C reaches the concentration value. The cumulative value of the third parameter C, i.e., the cumulative sum of the third parameter C is a level for determining a toner supply mode.

If the concentration value of the developer sensed by the concentration sensor 230 reaches the level for determining the toner supply mode, the controller 270 determines that the toner is significantly less than that as required. The controller 270 then suspends the print operation and controls the mixing driver 111 to mix the developer concurrently with the supply of the toner. The supply of the toner differs from a general supply of a toner of the image forming apparatus during the print operation in that the print operation is suspended for the consecutive supply of the toner. Until the output value of the concentration sensor 230 reaches a certain level, i.e. until the concentration of the toner reaches the setting value, the controller 270 supplies the toner and mixes the developer.

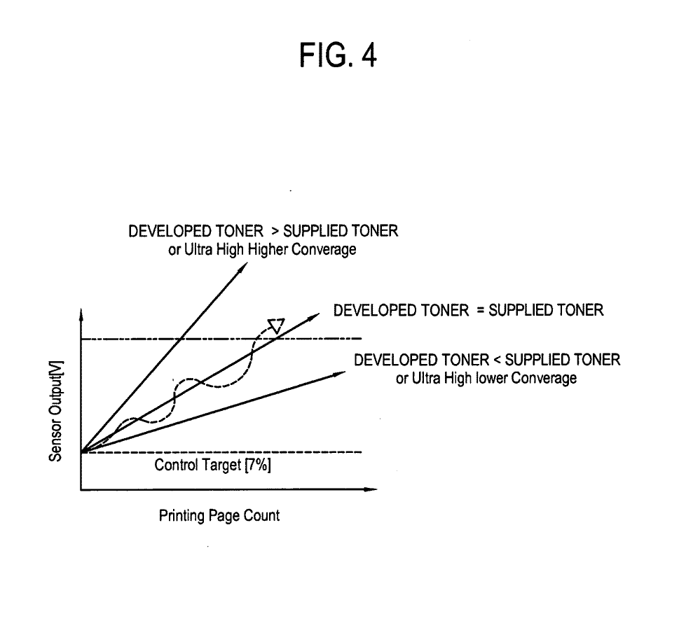

The exemplary embodiment prevents, during a print operation for the ultra coverage, inclination of raising the sensing output of the concentration sensor 230 from being larger and reaching the timing of starting the toner supply. More specifically, when the ultra high coverage is consecutively printed as in FIG. 4, the charging volume of the developer is drastically lowered and packing ratio increases and sensing output sharply rises. The rising inclination varies depending on whether the supply volume of the toner is larger or smaller than the consumed toner.

The inclination of the toner developing volume of the image forming apparatus changes when the control of the sensing output is not precise or the toner of the toner supply unit is consumed all and the toner is empty. Depending on the change in the inclination, a toner empty judge line which judges the toner empty becomes fast or slow.

Accordingly, the toner empty judge line, i.e., the timing of starting the toner supply varies.

The third parameter C cumulatively increases in proportion to an additional volume of the first parameter A. This reflects prevention of misunderstanding of the toner empty and oversupply of the toner due to the error in the concentration controlling sensor according to the changes in the packing of the developer occurring from the sharp rise of the output of the sensor with high coverage.

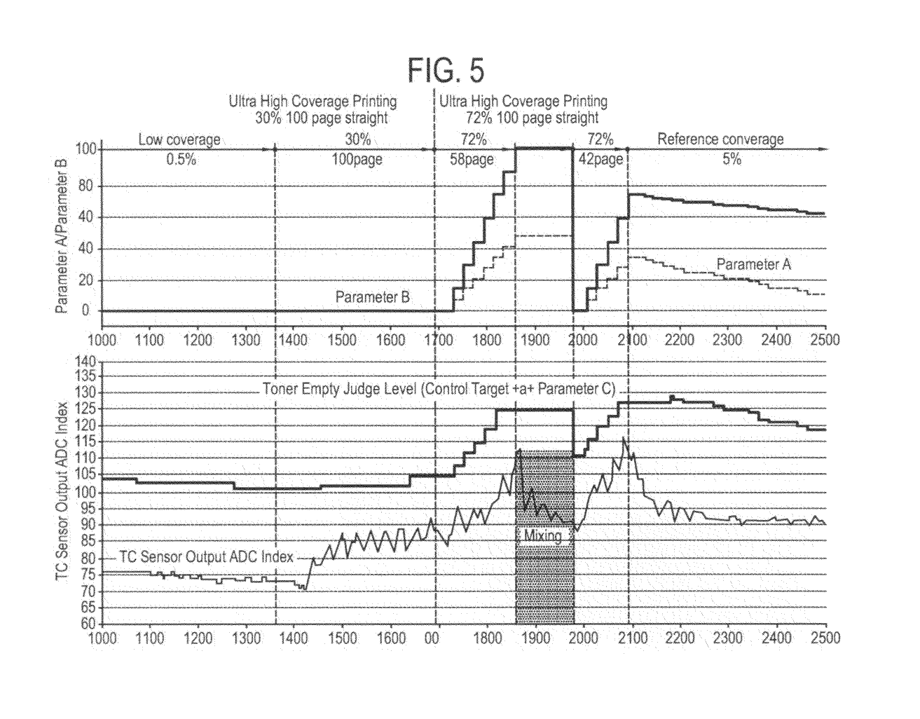

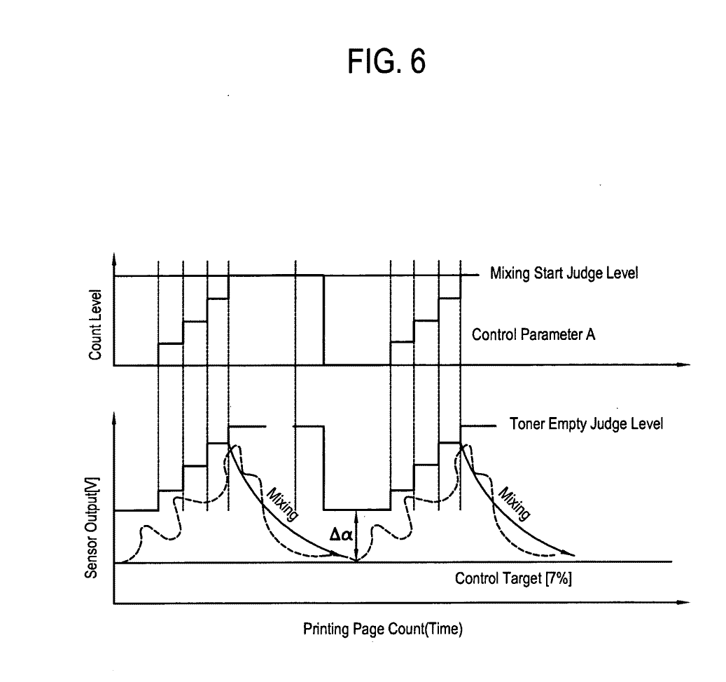

FIGS. 5 and 6 are graphs which sequentially illustrate the first to third parameters A, B and C and a concentration sensor output in the image forming apparatus according to the exemplary embodiment.

The controller 270 accumulates and varies the values of the first to third parameters A, B and C at every first interval while performing the print operation.

As shown in FIG. 5, if the cumulative value of the first parameter A is the mixing start judge level or more in the first range of 72%, the controller 270 suspends the print operation and controls the mixing driver 111 to mix the developer for the time corresponding to the cumulative value of the second parameter B.

In the first range of 72%, the cumulative values of the first to third parameters A, B and C all increase proportionally, and the TC sensor output also increases.

As in FIGS. 5 and 6, when the mixing operation is performed, the values of the first to third parameters A, B and C do not vary and the sensor output decreases according to the mixing operation.

If the mixing operation is completed, the first and second parameters A and B are reset as the initial value (zero), and the third parameter C also returns to its initial value. The controller 270 controls the image forming unit to resume the suspended print operation.

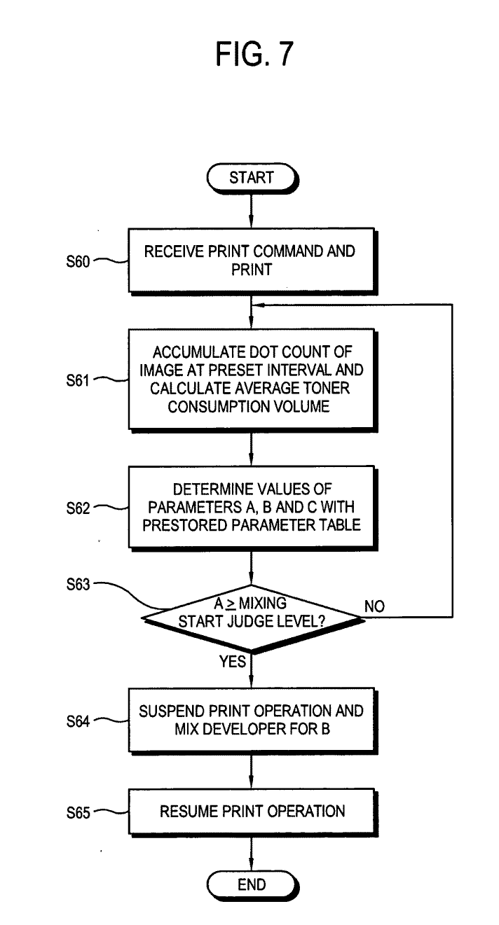

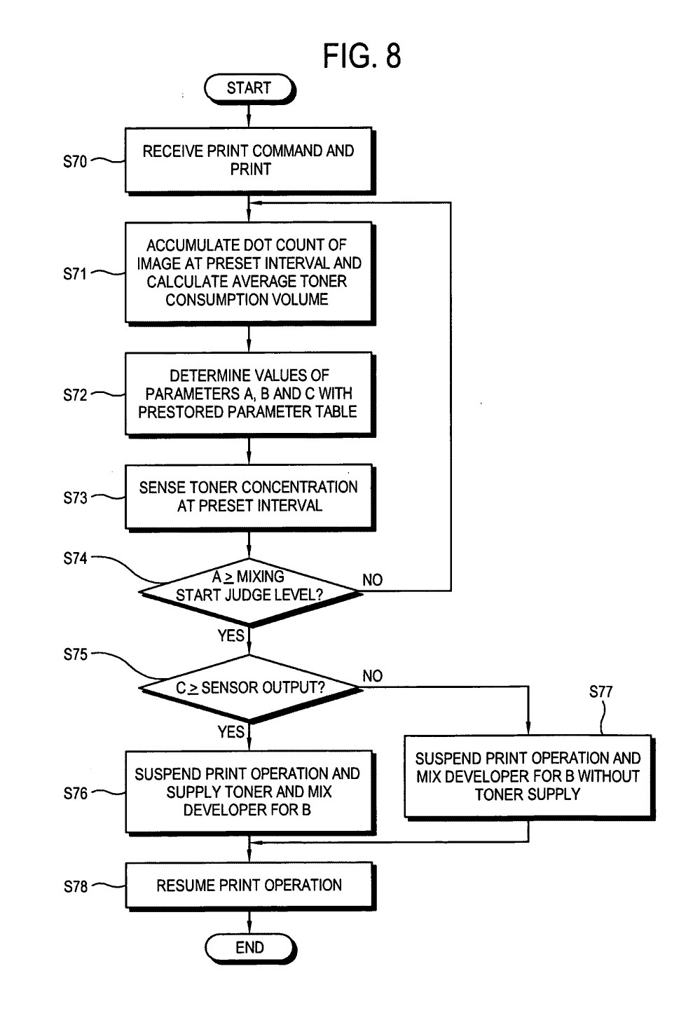

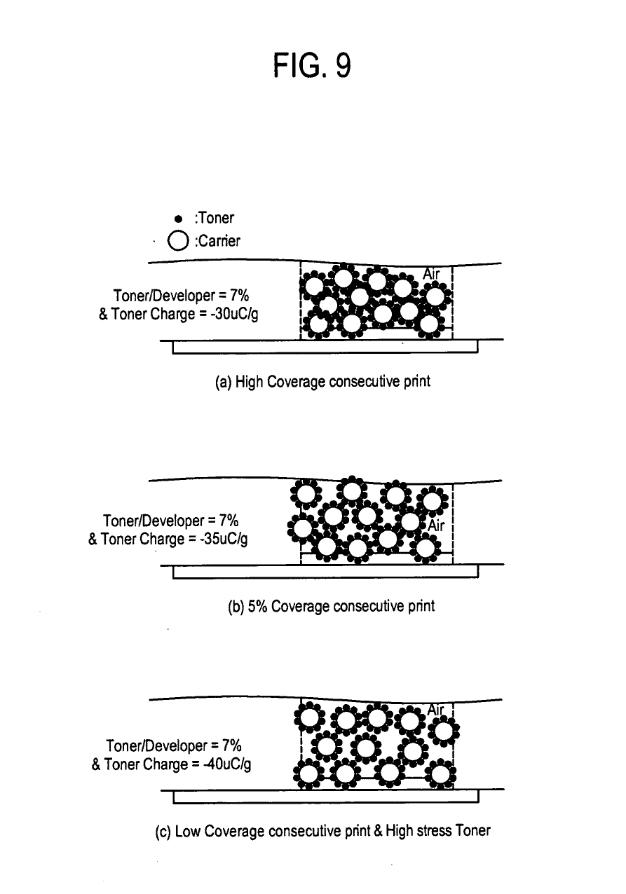

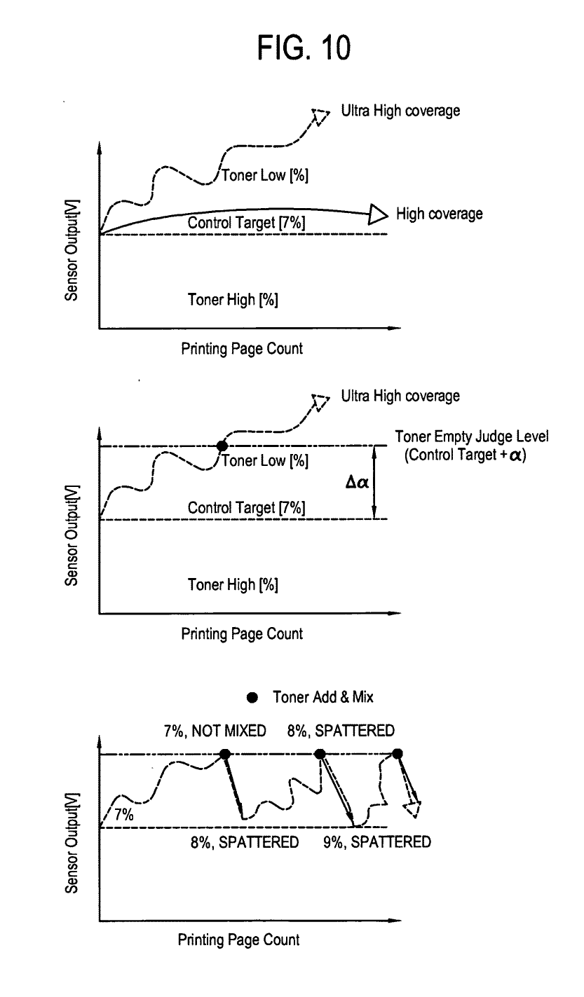

Hereinafter, a control method of the image forming apparatus having the foregoing configuration will be described with reference to FIGS. 7 and 8.

FIG. 7 is a flowchart which illustrates a control method of the image forming apparatus according to the exemplary embodiment.

As shown therein, the image forming apparatus receives a print command and performs a print operation (S60).

The controller 270 calculates the average toner consumption volume by accumulating the dot count of the image at the preset interval (first interval) (S61).

The controller 270 determines the values of the first to third parameters A, B and C according to the average toner consumption volume calculated at operation S61 by using the parameter table stored in the storage unit 250 (S62). The parameter table stores therein the value of the first parameter A for the timing of starting the mixing corresponding to the average toner consumption volume, the value of the second parameter B for the mixing time corresponding to the average toner consumption volume, and the value of the third parameter C for the timing of starting the toner supply corresponding to the average toner consumption volume. The values of the parameters are accumulated and stored at every preset first interval.

The controller 270 compares the cumulative value of the first parameter A determined at operation S62 with the mixing start judge level for the timing of starting the mixing (S63).

If it is determined that the cumulative value of the first parameter A is the mixing start judge level or more, the controller 270 suspends the print operation and mixes the developer for the time corresponding to the cumulative value of the second parameter B (S64).

If the mixing operation S64 is completed, the controller 270 resumes the suspended print operation (S65).

FIG. 8 is a flowchart which illustrates a control method of the image forming apparatus according to another exemplary embodiment.

As shown therein, the image forming apparatus receives a print command and performs a print operation (S70).

The controller 270 calculates the average toner consumption volume by accumulating a dot count of an image at a preset interval (first interval) (S71).

The controller 270 determines the values of the first to third parameters A, B and C according to the average toner consumption volume calculated at operation S71 by using the parameter table stored in the storage unit 250 (S72). The parameter table stores therein the value of the first parameter A for the timing of starting the mixing corresponding to the average toner consumption volume, the value of the second parameter B for the mixing time corresponding to the average toner consumption volume, and the value of the third parameter C for the timing of starting the toner supply corresponding to the average toner consumption volume. The values of the parameters are accumulated and stored at every preset first interval.

The controller 270 may receive an output value of the toner concentration of the developer 110 from the developer sensor 250 at a preset interval (second interval) (S73).

The controller 270 compares the cumulative value of the first parameter A determined at operation S72 with the mixing start judge level for the timing of starting the mixing (S74).

If it is determined that the cumulative value of the first parameter A is the mixing start judge level or more, the controller 270 compares the cumulative value of the third parameter C determined at operation S72 with the concentration value sensed at operation S73 (S75).

Determinations at operations S74 and S75 need not be performed sequentially. They may be made independently or only one determination may be made.

If the cumulative value of the third parameter C is the sensor output or more at operation S75, the controller 270 suspends the print operation and supplies the toner to the developing unit 130 and mixes the developer for the time corresponding to the cumulative value of the second parameter B (S76).

If the cumulative value of the third parameter C is lower than the sensor output at operation S75, the controller 270 suspends the print operation and mixes the developer for the time corresponding to the cumulative value of the second parameter B without supply of the toner from the developer supply unit 130 (S77).

If the mixing operation at operations S76 and S77 is completed, the controller 270 resumes the suspended print operation (S78).

As described above, an image forming apparatus and a control method thereof according to the exemplary embodiments prevent an oversupply of a toner due to an error in a concentration controlling sensor according to a change in packing of a developer, and in particular, maintains a uniform image concentration for a consecutive print operation with respect to an ultra high coverage and prevents a spatter of the toner, and maintains a print speed as quickly as possible.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A control method of an image forming apparatus which comprises a developer supply unit to supply a toner and a developing unit accommodating therein a two-component developer having the toner supplied by the developer supply unit and a carrier mixed, the control method comprising:
performing a print operation according to a print command;
calculating an average toner consumption volume of the image at a preset first interval;
determining a value of a first parameter according to the calculated average toner consumption volume by using a table storing therein in advance the value of the first parameter for a timing of starting mixing of the developer corresponding to the average toner consumption volume;
determining whether to start the mixing by using the determined value of the first parameter; and
suspending the print operation according to the determination result and mixing the two-component developer accommodated in the developing unit.

2. The control method according to claim 1, wherein the determining the value of the first parameter comprises accumulating the value of the first parameter at every preset first interval; and
the determining whether to start the mixing comprises comparing the cumulative value of the first parameter with a mixing start judge level.

3. The control method according to claim 1, wherein the prestored value of the first parameter is set as large if the average toner consumption volume is large and set as small if the average toner consumption volume is small.

4. The control method according to claim 1, wherein the table further stores therein a value of the second parameter for a mixing time corresponding to the average toner consumption volume; and
the determining the value of the first parameter comprises determining a value of the second parameter according to the calculated average toner consumption volume.

5. The control method according to claim 4, wherein the determining the value of the second parameter comprises accumulating the value of the second parameter at every preset first interval; and
the mixing the developer comprises mixing the developer for the time corresponding to the cumulative value of the second parameter.

6. The control method according to claim 4, wherein the value of the second parameter is set as large if the average toner consumption volume is large and set as small if the average toner consumption volume is small.

7. The control method according to claim 1, wherein the table further stores therein a value of the third parameter for a timing of starting the toner supply corresponding to the average toner consumption volume; and
the determining the value of the first parameter comprises determining a value of the third parameter according to the calculated average toner consumption volume.

8. The control method according to claim 7, further comprising sensing a concentration of the two-component developer accommodated in the developing unit at a preset second interval,
wherein the determining the value of the third parameter comprises accumulating the value of the third parameter at the preset first interval.

9. The control method according to claim 8, further comprising determining whether to supply the toner by comparing the sensed concentration of the developer and the cumulative value of the third parameter,
wherein the mixing the developer comprises supplying the toner and mixing the developer after suspending the print operation according to the determination result.

10. The control method according to claim 1, wherein the average toner consumption volume is set in each predetermined range with respect to a coverage of a printed image.

11. The control method according to claim 1, further comprising resuming the suspended print operation if the mixing operation is completed.

12. An image forming apparatus comprising:
a developer supply unit which supplies a toner;
an image forming unit which comprises a developing unit accommodating therein a two-component developer having a toner supplied by the developer supply unit and a carrier mixed, and comprising a mixer mixing the two-component developer and a mixing driver driving the mixer, and forms an image according to a print command;
a storage unit which stores therein a table storing in advance a value of a first parameter for a timing of starting a mixing of the developer corresponding to an average toner consumption volume; and
a controller which calculates an average toner consumption volume of the image at a preset first interval, determines a value of the first parameter according to the calculated average toner consumption volume by using the table, determines whether to mix the developer by using the determined value of the first parameter and controls the image forming unit to suspend the print operation according to a determination result and controls the mixing driver to mix the two-component developer accommodated in the developing unit.

13. The image forming apparatus according to claim 12, wherein the controller accumulates the value of the first parameter at the preset first interval and determines whether to start the mixing by comparing the cumulative value of the first parameter with a mixing start judge level.

14. The image forming apparatus according to claim 12, wherein the prestored value of the first parameter is set as large if the average toner consumption volume is large and set as small if the average toner consumption volume is small.

15. The image forming apparatus according to claim 12, wherein the table further stores therein a value of the second parameter for a mixing time corresponding to the average toner consumption volume, and the controller further determines a value of the second parameter according to the calculated average toner consumption volume.

16. The image forming apparatus according to claim 15, wherein the controller accumulates the value of the second parameter at the preset first interval and controls the mixing driver to mix the developer for a time corresponding to the cumulative value of the second parameter.

17. The image forming apparatus according to claim 16, wherein the value of the second parameter is set as large if the average toner consumption volume is large and set as small if the average toner consumption volume is small.

18. The image forming apparatus according to claim 12, wherein the table further stores therein a value of the third parameter for a timing of starting a toner supply corresponding to the average toner consumption volume, and the controller further determines a value of the third parameter according to the calculated average toner consumption volume.

19. The image forming apparatus according to claim 18, further comprising a concentration sensor which senses a concentration of the two-component developer accommodated in the developing unit at a preset second interval, wherein
the controller accumulates the value of the third parameter at the preset first interval.

20. The image forming apparatus according to claim 19, wherein the controller further determines whether to supply the toner by comparing the sensed concentration of the developer with the cumulative value of the third parameter, and supplies the toner and mixes the developer after suspending the print operation according to the determination result.
